(19) United States
(12) Patent Application Publication
(10) Pub. No.: US 2014/0280175 A1
(43) Pub. Date: Sep. 18, 2014

(54) SYSTEM AND METHOD FOR FACILITATING PRODUCT SEARCH WITHIN AN ELECTRONIC PRODUCT CATALOG

(71) Applicant: W.W. GRAINGER, INC., Lake Forest, IL (US)

(72) Inventor: Irena Gelfand, Chicago, IL (US)

(73) Assignee: W.W. GRAINGER, INC., Lake Forest, IL (US)

(21) Appl. No.: 13/834,023

(22) Filed: Mar. 15, 2013

(51) Int. Cl. G06F 17/30

(52) U.S. Cl. CPC G06F 17/30713
USPC 707/740

(57) ABSTRACT

An user interface for a general product category has an interactive product informational section which presents a plurality of first level product categories for product within the general product category and a plurality of user interface elements for use in expanding and collapsing each of the plurality of first level product categories to thereby provide selective access to a second level of product information for product within the corresponding first level product category. The second level of product information is in the form of a table in which is listed characteristic information for individual products within the corresponding first level product category. Each row within the table includes characteristic information for individual products within the corresponding first level product category and has an associated user interface element for causing a display of more detailed information for a corresponding one of the individual products.

### BACKGROUND

Systems and method for searching within electronic product catalogs are generally known in the art. For example, U.S. Published Application No. 2001/0044758 discloses systems and methods for searching an electronic product catalog in such a manner that it is easy to search, drill down, drill-up and drill across products using multiple, independent hierarchical category taxonomies of the products in the electronic product catalog.

### SUMMARY OF THE INVENTION

The following describes an improved system and method for searching within an electronic product catalog. More particularly, the system and method provides an user interface for a general product category having an interactive product informational section in which is presented a plurality of first level product categories for product within the general product category and a plurality of user interface elements for use in expanding and collapsing each of the plurality of first level product categories to thereby provide selective access to a second level of product information for product within the corresponding first level product category. The second level of product information is in the form of a table in which is listed characteristic information for individual products within the corresponding first level product category. Each row within the table includes characteristic information for individual products within the corresponding first level product category and has an associated user interface element for causing a display of more detailed information for a corresponding one of the individual products.

While the forgoing provides a general explanation of the subject invention, a better understanding of the objects, advantages, features, properties and relationships of the subject invention will be obtained from the following detailed description and accompanying drawings which set forth illustrative embodiments and which are indicative of the various ways in which the principles of the subject invention may be employed.

### BRIEF DESCRIPTION OF THE DRAWINGS

For a better understanding of the subject invention, reference may be had to a preferred embodiment shown in the attached drawings in which:

FIG. 1 is a block diagram illustrating components of an exemplary network system in which the subject method may be employed; and

FIG. 2 is a screen shot of an exemplary user interface for locating products of interest within an electronic product catalog.

### DETAILED DESCRIPTION

With reference to the figures, a system and method for facilitating product search within an electronic product catalog is now described. While not intended to be limiting, the system and method will be described in the context of a plurality of processing devices linked via a network, such as a local area network or a wide area network, as illustrated in FIG. 1. In this regard, a processing device 20, illustrated in the exemplary form of a computer system, is provided with executable instructions to, for example, provide a means for a consumer, i.e., a user, to access a remote processing device, e.g., a server system 68, via the network to, among other things, perform a search for the purpose of locating product of interest within an electronic product catalog. Generally, the computer executable instructions reside in program modules which may include routines, programs, objects, components, data structures, etc. that perform particular tasks or implement particular abstract data types. Accordingly, those skilled in the art will appreciate that the processing device 20 may be embodied in any device having the ability to execute instructions such as, by way of example, a personal computer, mainframe computer, personal-digital assistant (“PDA”), cellular or smart telephone, tablet computer, or the like. Furthermore, while described and illustrated in the context of a single processing device 20, those skilled in the art will also appreciate that the various tasks described hereinafter may be practiced in a distributed environment having multiple processing devices linked via a local or wide-area network whereby the executable instructions may be associated with and/or executed by one or more of multiple processing devices, e.g., in a cloud computing environment.

For performing the various tasks in accordance with the executable instructions, the processing device 20 preferably includes a processing unit 22 and a system memory 24 which may be linked via a bus 26. Without limitation, the bus 26 may be a memory bus, a peripheral bus, and/or a local bus using any of a variety of bus architectures. As needed for any particular purpose, the system memory 24 may include read only memory (ROM) 28 and/or random access memory (RAM) 30. Additional memory devices may also be made accessible to the processing device 20 by means of, for example, a hard disk drive interface 32, a magnetic disk drive interface 34, and/or an optical disk drive interface 36. As will be understood, these devices, which would be linked to the system bus 26, respectively allow for reading from and writing to a hard disk 38, reading from or writing to a removable magnetic disk 40, and reading from or writing to a removable optical disk 42, such as a CD/DVD ROM or other optical media. The drive interfaces and their associated non-transient, computer-readable media allow for the nonvolatile storage of computer readable instructions, data structures, program modules and other data for the processing device 20. Those skilled in the art will further appreciate that other types of non-transient, computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example, via a network connection.

The consumer may enter commands and information into the processing device 20, e.g., a textual search query, a selection input, etc., through input devices such as a keyboard 54 and/or a pointing device 56. While not illustrated, other input devices may include a microphone, a joystick, a game pad, a scanner, a camera, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information from the processing device 20, a monitor 60 or other type of display device may also be connected to the bus 26 via an interface, such as a video adapter 62. In addition to the monitor 60, the processing device 20 may also include other peripheral output devices, not shown, such as speakers and printers.

The processing device 20 may also utilize logical connections to one or more remote processing devices, such as the server system 68 having one or more associated data repositories 68A, e.g., a database in which is stored product information and product relationships. In this regard, while the server system 68 has been illustrated in the exemplary form of a computer, it will be appreciated that the server system 68 may, like processing device 20, be any type of device having processing capabilities. Again, it will be appreciated that the server system 68 need not be implemented as a single device but may be implemented in a manner such that the tasks performed by the server system 68 are distributed to a plurality of processing devices linked through a communication network. Additionally, the server system 68 may have logical connections to other third party server systems via the network 12 and, via such connections, will be associated with data repositories and/or functionalities that are associated with such other third party server systems.

For performing tasks as needed, the server system 68 may include many or all of the elements described above relative to the processing device 20. By way of further example, the server system 68 includes executable instructions stored on a non-transient memory device for, among other things, handling search requests, providing search results, providing access to context related services, etc. Communications between the processing device 20 and the server system 68 may be exchanged via a further processing device, such as a network router, that is responsible for network routing. Communications with the network router may be performed via a network interface component 73. Thus, within such a networked environment, e.g., the Internet, World Wide Web, LAN, or other like type of wired or wireless network, it will be appreciated that program modules depicted relative to the processing device 20, or portions thereof, may be stored in the memory storage device(s) of the server system 68.

To store the product information that is to be returned as a search result in response to one or more keywords, drill-down selections, or the like (i.e., “a search query”) being submitted to a search engine operating on the server system 68, the one or more data repositories 68A associated with the server system 68 preferably utilize an ontology, i.e., a structural framework for organizing information. In the exemplary context of online commerce, such an ontology generally manifests itself as a product hierarchy or product “tree.” As will be appreciated, when such a product hierarchy is traversed from the top most level (i.e., the most abstract and least specific) to the bottom most level (i.e., most specific), products within the product hierarchy tend to share more and more attributes or parameters, i.e., characteristics, in common. In certain circumstances, products which tend to share like characteristics can be grouped together.

To facilitate searching for product within the electronic product catalog, an exemplary user interface 200 is shown in FIG. 2. The exemplary user interface 200 would be displayed on the computing device 20, for example using a browser application, such that consumer interactions with the exemplary user interface 200, via one or more of the associated input device, will cause the issuance of corresponding signals to the server system 68 whereupon the server system 68 will respond by modifying the user interface as appropriate. While FIG. 2 illustrates the exemplary user interface 200 being utilized to locate product within the fastening hardware product category, it is to be understood that this example is not intended to be limiting. Rather, those of skill in the art will understand that the methods and user interface elements described hereinafter can be utilized to locate any appropriate type of product and/or services (individually and collectively referenced as “product” within this document) within an electronic product catalog as desired.

More particularly, the exemplary user interface 200 is caused to be displayed in response to a consumer indicating, for example via submission of a keyword query, drill-down query, or the like, that the consumer desires to locate product in the “hex head cap screws” general product category. Thus, for the convenience of the consumer, the user interface 200 provides to the consumer an indication 202 of the general category of product to which the displayed user interface 200 pertains as well as number of products 204 from the electronic product catalog that are within the general category of product indicated by the consumer. For allowing the consumer to locate specific product of interest within the general product category, the user interface 200 also provides an interactive filtering section 206 and an interactive product information section 208.

Considering first the interactive product information section 208, the interactive product information section 208 provides the consumer with the ability to access various levels of products that have been categorized for inclusion within the general product category. Generally, product sharing one or more common characteristics are placed within a first level product category and individual products that share the one or more common characteristics will comprise the second level of the first level product category. Thus, while the second level products will share one or more common characteristics (which one or more common characteristics are used to define the first level product category) the second level product may have one or more uncommon characteristics which make the products with the second level product category unique with respect to each other. In this example, in the first level product category of “Hex Cap, Machine Screws” the second level products may differ by thread length, thread size, and/or grade. The subject user interface provides a means for the consumer to quickly access such information.

In the illustrated example, the product information section 208 presents in a consumer selectable list view or grid view 209 a listing of first level product categories 210 that have been defined for the general product category. Each of the first level product categories can include a representative image 214 of product from the electronic product catalog that has been assigned to the corresponding first level product category, a representative text descriptor 216 for product within the first level product category, and a representative price 218 for product within the first level product category. The interactive product information section 208 additionally provides interface elements 220 for allowing the consumer to change the number of first level product categories that are to be displayed to the consumer within the interactive product information section 208 and interface elements 222 for allowing the consumer to page through the first level product categories that are displayed to the consumer within the interactive product information section 208.

To provide information about the product in the second level product category, the interactive product information section 208 can include an indication 226 of the number of second level products within the first level product category as well as a user interface element 229 by which the consumer can expand or collapse the view to show relevant information for the second level product within the first level product category. In the event that the consumer interacts with the user interface element 229 to expand the view to show relevant information for the product that is included within a second level product category of a first level product category, a “sticky header” 230 is provided within the product information section 208 at the relevant location within the product information section 208 as shown in FIG. 2. The “sticky header” 230 is locked to the top of the expanded second level product informational area 231, e.g., the “sticky header” will not move when the second level product information is scrolled, and functions to identify via use of labels the differing characteristics of the products that are included within the second level product category. In this example, the “sticky header” 230 informs the consumer that the product information for the product within the second level product category is presented in a table format in which the product sku is listed in a first column of the table, the product thread length is listed in a second column of the table, the product thread size is listed in a third column of the table, the product grade is listed in a fourth column of the table, the product availability is listed in a fifth column of the table, etc. As before, user interface elements 233 can be provided to allow the consumer to see the number of product entries that are currently being presented within the second level product informational area 231 and for allowing the consumer to change the number of product entries that are currently being presented within the second level product information area 231.

For each product table entry within the second level product informational area 231 a user interface element 236 can be provided to allow the consumer to access more detailed product information for a particular product of interest to the consumer. By way of example, a consumer can interact with user interface element 236 to collapse or expand information for a specific product within the product informational area 231. In the illustrated example, the consumer has elected to expand, i.e., elected to view, the specific product information for the product corresponding to sku “138A1” in which case the system server 68 causes to be displayed in the product informational area 231 a representative image 240 of the product corresponding to sku “138A1,” product review information 241 for the product corresponding to sku “138A1,” a link 242 to an item detail page for the product corresponding to sku “138A1,” a link 243 to a catalog page on which the product corresponding to sku “138A1” may be found, technical specifications 244 for the product corresponding to sku “138A1,” links 245 to media related to the product corresponding to sku “138A1,” and/or other product specific information as desired. In addition, the system server 68 may cause the presentation of information 246 for product that has been otherwise related to the product corresponding to sku “138A1,” such as product that is commonly purchased with the product corresponding to sku “138A1,” product that is commonly viewed during an on-line session in which the product corresponding to sku “138A1” is also viewed, etc.

Additionally provided within the interactive product information section 208 are preferably included user interface elements for allowing the consumer to add desired product to a list, e.g., a wish list, a shopping cart, or the like as is conventional within the art. It is also contemplated that a consumer interaction with an image, text, or the like within the interactive product information section, recommended product area, or the like can cause the system server to present a “quick view” of relevant product information and/or links to relevant product information/functionalities as described in commonly assigned U.S. Pat. No. 8,341,030 which is incorporated herein by reference in its entirety.

For allowing the consumer to further refine the product information that is presented within the product information section 208, e.g., to filter the first level product categories that are presented within the product information section 208 and/or the product that is to be included within the second level product categories, the interactive filtering section 206 provides a user interface element 250 adapted to accept input whereby the consumer may filter, i.e., search within the results, for product having one or more keywords. Additionally, user interface elements 252 may be provided to accept input whereby the consumer may filter, i.e., search within the results, for product having one or more desired product characteristics. Such user interface elements 252 can include check boxes with corresponding alphanumeric descriptors, selectable image representations of characteristics, or the like without limitation.

While various concepts have been described in detail, it will be appreciated by those skilled in the art that various modifications and alternatives to those concepts could be developed in light of the overall teachings of the disclosure. For example, while described in the context of a networked system, it will be appreciated that the electronic product catalog can be included on the consumer computing device 20. Further, while various aspects of this invention have been described in the context of functional modules and illustrated using block diagram format, it is to be understood that, unless otherwise stated to the contrary, one or more of the described functions and/or features may be integrated in a single physical device and/or a software module, or one or more functions and/or features may be implemented in separate physical devices or software modules. It will also be appreciated that a detailed discussion of the actual implementation of each module is not necessary for an enabling understanding of the invention. Rather, the actual implementation of such modules would be well within the routine skill of an engineer, given the disclosure herein of the attributes, functionality, and inter-relationship of the various functional modules in the system. Therefore, a person skilled in the art, applying ordinary skill, will be able to practice the invention set forth in the claims without undue experimentation. It will be additionally appreciated that the particular concepts disclosed are meant to be illustrative only and not limiting as to the scope of the invention which is to be given the full breadth of the appended claims and any equivalents thereof.

What is claimed is:

1. A computer readable media embodied in a non-transient, physical memory device having stored thereon computer executable instructions for facilitating product search result within an electronic product catalog, the instructions perform steps comprising:
receiving a request to search for product within a general product category;
causing an user interface for the general product category to be displayed in a consumer computing device, the user interface for the general product category comprising an interactive product informational section wherein the interactive product informational section presents a plurality of first level product categories for product within the general product category and a plurality of user interface elements for use in expanding and collapsing each of the plurality of first level product categories to thereby provide selective access to a second level of product information for product within the corresponding first level product category for product within the general product category;
wherein the second level of product information comprises a table in which is listed characteristic information for individual products within the corresponding first level product category for product within the general product category and wherein the table comprises a sticky header in which is presented labels for columns within the table; and
wherein each row within the table in which is listed characteristic information for individual products within the corresponding first level product category for product within the general product category has an associated user interface element for causing a display of more detailed information for a corresponding one of the individual products within the corresponding first level product category for product within the general product category.

2. The computer readable media as recited in claim 1, wherein the user interface for the general product category further comprises an interactive filtering section providing user interface elements for filtering information presented in the interactive product informational section.

3. The computer readable media as recited in claim 2, wherein a consumer interaction with the user interface element for causing a display of more detailed information for a corresponding one of the individual products within the corresponding first level product category for product within the general product category also causes a display of information for product that is related to the corresponding one of the individual products within the corresponding first level product category for product within the general product category.

4. The computer readable media as recited in claim 3, wherein the product that is related to the corresponding one of the individual products within the corresponding first level product category for product within the general product category comprises product that has been purchased in the past with the product that is related to the corresponding one of the individual products within the corresponding first level product category for product within the general product category.

5. The computer readable media as recited in claim 3, wherein the product that is related to the corresponding one of the individual products within the corresponding first level product category for product within the general product category comprises product that has been viewed in the past during an on-line session with the product that is related to the corresponding one of the individual products within the corresponding first level product category for product within the general product category.

6. The computer readable media as recited in claim 2, wherein each of the plurality of first level product categories for product within the general product category comprises a representative product image and a representative product descriptor.

7. The computer readable media as recited in claim 6, wherein the detailed information for a corresponding one of the individual products within the corresponding first level product category for product within the general product category comprises an image of the individual product, an obtained rating for the individual product, a description of the individual product, and a price for the individual product.

8. The computer readable media as recited in claim 7, wherein the detailed information for a corresponding one of the individual products within the corresponding first level product category for product within the general product category comprises a link to an informational video that is related to the individual product.

9. The computer readable media as recited in claim 7, wherein the detailed information for a corresponding one of the individual products within the corresponding first level product category for product within the general product category comprises a link to a page of an electronic version of a catalog on which the individual product is located.

10. The computer readable media as recited in claim 7, wherein the user interface for the general product category comprises a display of a number of product within the general product category.

11. The computer readable media as recited in claim 10, wherein each of the plurality of first level product categories for product within the general product category comprises a display of a number of product within the corresponding one of the first level product category for product within the general product category.
